(19) United States
(12) Patent Application Publication
(10) Pub. No.: US 2008/0295709 A1
(43) Pub. Date: Dec. 4, 2008

(54) Press, Guide For a Guide Element of a Press

(76) Inventor: Eugen Rapp, Berg (DE)

Correspondence Address: JORDAN AND HAMBURG LLP, 122 EAST 42ND STREET, SUITE 4000, NEW YORK, NY, 10168, US

(21) Appl. No.: 11/630,503

(22) PCT Filed: Jun. 2, 2005
(86) PCT No.: PCT/DE2005/000998

§ 371 Date: Jun. 6, 2007

(30) Foreign Application Priority Data
Jun. 22, 2004 (DE) 10 2004 030 194.8

(51) Int. Cl. B30B 5/00

(52) U.S. Cl. 100/245

(57) ABSTRACT

A press and to a guide for a guide element of a press are disclosed. A tool receiving element is integrated into the guide element such that the tool can be guided in a wear-resistant manner.

The invention starts out from a press, particularly from a small press of the type of claim 1, and from a guiding system for a guiding element of a press, particularly of a press of claims 1 to 9, of the type of claim 9.

Presses, which consist of a press frame, a mechanical, pneumatic or hydraulic driving mechanism and a die, have long been a part of the prior art (for example, British patent 587,363, U.S. Pat. No. 2,057,447, British patent 606,871, DE-C-854748, DE-A-4233233). With them, a pressure is transferred to a workpiece, which is resting on a press table. Presses are used, for example, for molding, stamping, assembling, embossing, riveting, flaring, caulking, numbering, cutting out and pressing in bushings. It is particularly important here that the movable die can be guided precisely and exactly, so that wear and rejects are decreased.

The DE 33 24 866 A1 discloses an eccentric press of the generic type, for which a die is disposed at a frame part, which is movable in the lifting direction and the lower part of which grips below the press table. Precisely guiding the guide becomes possible due to a guiding system, which is below the working table. However, a high structural expenditure is required because of the box-like construction of the frame element.

The DE 40 01 993 A1 discloses a press of the generic type, with which precise guidance of the die is possible. This is achieved owing to the fact that the guiding system of the die is connected with the frame of the press only at points the mode from the driving mechanism. However, a high structural expenditure is also required for this purpose.

On the other hand, the inventive press, especially a small press with the characterizing distinguishing features of claim 1, and the inventive guiding system for a guiding element of a press, especially a press of one of the claims 1 to 9, with the characterizing distinguishing features of claim 10, are of advantage due to the integration of the die seat in one end of the guiding element.

According to an advantageous development of the invention, the die, which can be taken up, is a ram.

According to an additional advantageous development of the invention, the guiding system is a guiding rail.

According to an additional advantageous development of the invention, the guiding rail is a linear guiding rail.

According to an additional advantageous development of the invention, the guiding system and/or the guiding element have a bearing.

According to a development of the invention, advantageous in this respect, the bearing is a ball bearing.

According to a development of the invention, advantageous in this respect, the bearing is a recirculating ball bearing.

According to a development of the invention, advantageous in this respect, the bearing is a plain bearing.

According to an additional advantageous developments of the invention, a driving mechanism is mechanical (hand operated).

According to an additional advantageous development of the inventive guiding system, the die seat is disposed on the side of the guiding element facing the workpiece, which is to be processed by the press.

According to an additional advantageous development of the inventive guiding system, the die seat continues to be guided by the guiding system at all times during the operation of the press.

Further advantages and advantageous developments of the invention may be inferred from the following description, the drawing and the claims.

Examples of the object of the invention are explained in greater detail in the following and shown in the drawing, in which

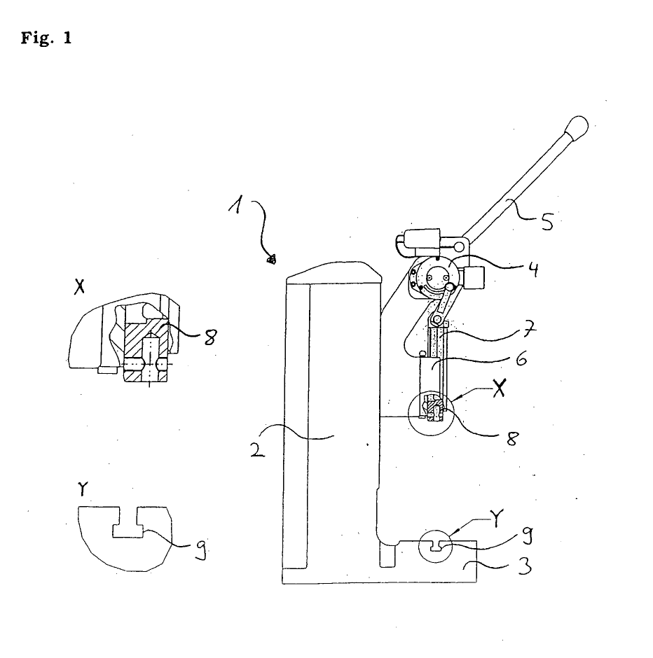

FIG. 1 shows a side view of an inventive press with detail drawings X and Y.

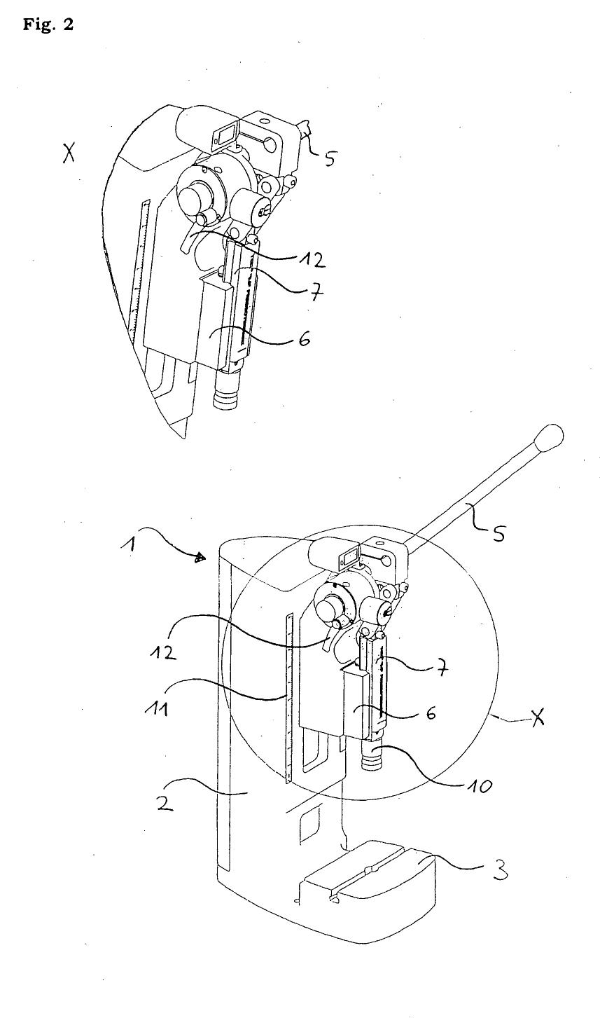

FIG. 2 shows a perspective view of an inventive press with the detail drawing X,

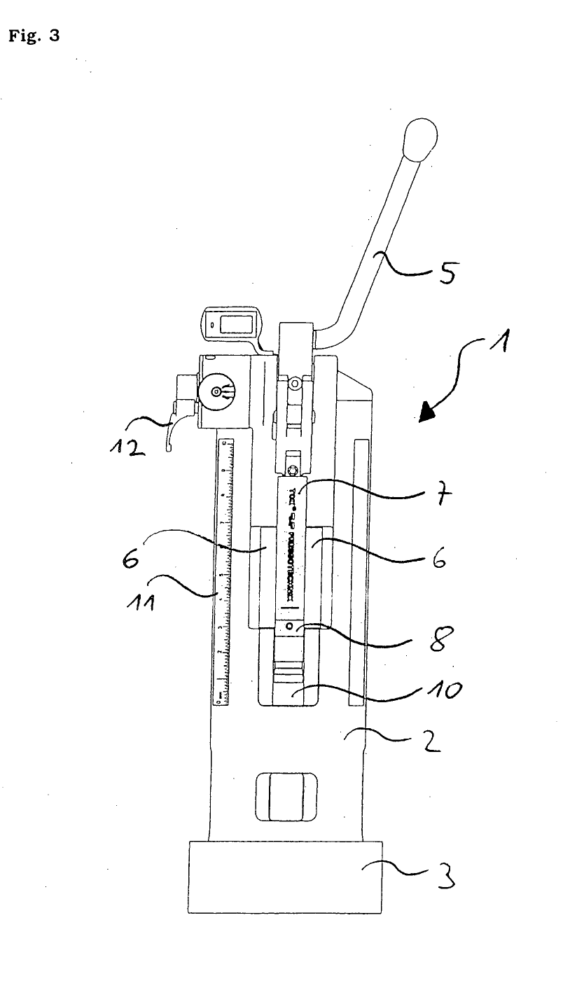

FIG. 3 shows a front view of an inventive press and

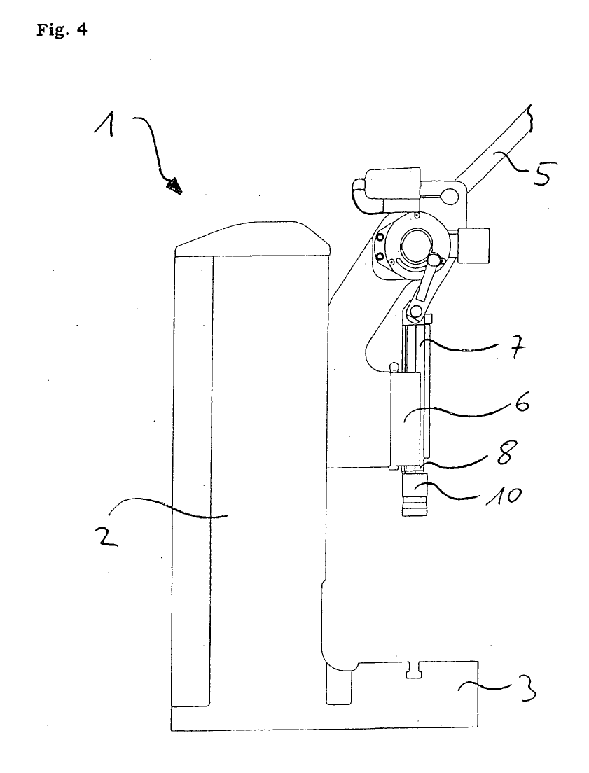

FIG. 4 shows a side view of an inventive press.

FIG. 1 shows a side view of an inventive press 1 with the detail drawings X and Y. The press 1 consists of a press frame 2, a working table 3, a driving mechanism 4, which, in this case, is operated mechanically by means of a lever 5, which can be returned to its starting position preferably by means of a spring, and a guiding element 7, which is disposed movably in a guiding system 6. A die seat 8, which is shown on an enlarged scale in the detail drawing X, is represented at the guiding element 7 at the side facing the working table 3. The die seat 8, which can also, of course, be configured differently, is intended for the simple and rapid assembly and disassembly of a die, which is not shown here and with which a workpiece, which is also not shown, is processed. Advantageously, the workpiece is fixed to the die, for example, by a T groove, which is shown on an enlarged scale in the detail drawing Y.

FIG. 2 shows a perspective view of an inventive press 1 with the detail drawing X. An easily exchangeable die, here a ram, the installed height of which can be adjusted infinitely variably and read at a scale 11, is disposed at the guiding element 7. The distance of the ram travel can also be adjusted infinitely variable by a set screw 12. By operating the lever 5, the guiding element 7 with the ram 10 is guided to the die, which is not shown, over a driving mechanism 4, which can also be configured differently (for example, as a rack construction). Due to the construction of the inventive press 1, which is compact and cost effective, and especially due to the guiding element 7, which is guided in the guiding system 6, the inventive press 1 has a long service life (wear-resistant). In addition, it is robust in use, not sensitive to dirt and can be guided easily, accurately and smoothly. It is also advantageous that standard components may be used.

All the distinguishing features, represented in the specification, the drawing or the claims, may be essential to the invention individually as well as in any combination with one another.

### LIST OF REFERENCE SYMBOLS

1. Press
2. Frame of press
3. Working table
4. Driving mechanism
5. Lever
6. Guiding system
7. Guiding element
8. Die seat
9. T groove
10. Ram
11. Scale
12. Set screw

1. A press comprising a press frame, a driving mechanism, a working table, a guiding element guided by at least one guiding system, a die seat for accommodating a die, the die seat being disposed at the end of the guiding element facing the working table, the driving mechanism being disposed at the end of the guiding element, which is opposite to the die seat, and the guiding system and/or the guiding element have a ball bearing, a recirculating ball bearing or a plain bearing.

2. The press of claim 1, wherein the die, which can be accommodated, is a ram.

3. The press of claim 1, wherein the guiding system is a guiding rail.

4. The press of claim 3, wherein the guiding rail is a linear guiding rail.

5-8. (canceled)

9. The press of claim 1, wherein the driving mechanism is mechanical.

10. A system for a guiding element of a press according to claim 1, wherein the guiding element has a die seat at one end.

11. The guiding system of claim 10, wherein the die seat is disposed on the side of the guiding element facing a workpiece which is to be processed by the press.

12. The guiding system of claims 10, wherein the die seat remains guided by the guiding system at all times during the operation of the press.

13. The press of claim 1, wherein the driving mechanism is hand operated.
